(19) United States
(12) Patent Application Publication
(10) Pub. No.: US 2025/0116538 A1
(43) Pub. Date: Apr. 10, 2025

(54) Condition Monitoring for Rotatable Elements

(71) Applicant: Siemens Aktiengesellschaft, Muenchen (DE)

(72) Inventors: Dirk SCHEIBNER, Nuernberg (DE); Ulf BORMANN, Altdorf (DE); Jürgen SCHIMMER, Nürnberg (DE); Roland FINKLER, Erlangen (DE)

(21) Appl. No.: 18/910,167

(22) Filed: Oct. 9, 2024

(30) Foreign Application Priority Data
Oct. 10, 2023 (EP) 23202723

(51) Int. Cl. G01D 5/347; G01D 21/02; G01P 3/489; H02K 11/21

(52) U.S. Cl. CPC G01D 5/3473; G01D 21/02; G01P 3/489; H02K 11/21

(57) ABSTRACT

A method for monitoring a condition of a rotating element, in particular an electric machine, includes acquiring, by a first sensor, a first measured variable dependent on the rotational position of the rotatable element and outputting a rotation signal corresponding to the first measured variable, ascertaining a clock rate of the acquisition of the first measured variable via a processing unit or via a separate evaluation unit, acquiring, by a second sensor of the rotational speed acquisition unit, a second measured variable different from the first measured variable and outputting a measuring signal corresponding to the second measured variable, adjusting the clock rate of the acquisition of the second measured variable by taking into account the ascertained clock rate of the acquisition of the first measured variable, and using the rotation signal and the measuring signal adjusted to the rotation signal to monitor the condition of the rotating element.

### BACKGROUND OF THE INVENTION

### 1. Field of the Invention

The invention to a rotational speed acquisition unit, in particular a rotary encoder, relates to a technical unit that includes a rotating element and a rotational speed acquisition unit, relates to a system with a rotational speed acquisition unit or a technical unit, and a separate acquisition unit, and relates to a method for monitoring a condition of a rotating element, in particular an electric machine.

### 2. Description of the Related Art

Rotary encoders serve to measure distances, speeds or angles of rotation of a rotatable object connected to the rotary encoder. For this purpose, the rotary encoders have a sensor for acquiring a rotational position or change in rotational position. Rotary encoders of this kind are capable of acquiring an angle of rotation with very high rotation angle resolution, for example, with a resolution of 0.1°.

In the industrial environment rotary encoders are used, for example, in machine tools, in handling and automation technology and on measuring and testing facilities.

The rotary encoder can be, for example, an encoder that acquires the absolute angle of rotation position and that outputs a corresponding encoded signal. The rotary encoder can also be an incremental rotary encoder that outputs, for example, two signals mutually offset by 90°. Relative changes in the angle of rotation can be ascertained from the two rotary encoder signals.

Incremental rotary encoders that also output a reference signal at a predetermined angle of rotation are also known. The absolute angle of rotation can be derived by evaluating this signal.

Rotary encoders can be based, for example, on a photoelectric or magnetic principle. In the former case, a light beam that, as a rule, is generated by an LED, is guided by a scanning reticle provided with lines or slits onto a photo optic sensor (as a rule a phototransistor). When the scanning reticle rotates, the light beam is cyclically modulated between LED and phototransistor. A corresponding rotary encoder signal may be generated from the modulated signal of the phototransistor.

Rotary encoders of this kind can be attached, for example, to a rotor shaft end of an electric machine for acquiring the change in rotational position of the rotor shaft. The rotary encoder can alternatively be connected to the rotor shaft via a toothed belt. The rotary encoder signals are conventionally required for monitoring and/or regulating the electric machine. The electric machine can be, for example, an electric motor or a generator. It can be an asynchronous or synchronous machine.

“Condition Monitoring” is used, in particular, in the industrial environment for condition-oriented maintenance of rotating machines. Since outages of the monitored machines can result in safety-critical conditions as well as major costs—not just in the machine itself but primarily also in the subsequent processes—condition monitoring is used to prevent such outages.

Based on the data, which is obtained by condition monitoring, the condition of the monitored machine can be analyzed and the servicing, repair or replacement of the machine can be brought about in a condition-oriented manner accordingly.

This results in a great cost-saving potential because the life of critical machine elements can be exploited more effectively and at the same time necessary maintenance measures can be terminated in conjunction with the production plan.

Vibration and other sensor signals are evaluated in order to monitor the condition of rotating systems. Particular frequencies in the frequency spectrum of the sensor signals are analyzed for this purpose. The frequencies to be considered in this connection substantially depend on the rotational speed of the rotating machine. In this regard, a fundamental requirement for both calculating the frequency spectrum and for analyzing the frequencies to be considered is that the rotational speed is constant over a relatively long period. This is frequently not the case in practice, however.

One possibility for avoiding these problems is an order analysis. This means that instead of selected frequencies, multiples of the rotational speed are analyzed. Such an order analysis is also possible, even if the rotational speed changes during the period under consideration. In order for this to be possible, however, the rotational speed within the period under consideration must be continuously known. The sensor values can consequently be based on the rotational speed instead of on the time.

In order to implement condition monitoring on rotating machines, even during dynamic operation, a condition monitoring system with additional rotational speed acquisition has previously been required. However, four- to five-figure costs result in this connection due to the system, so such a condition monitoring is only worthwhile for high-end rotating machines.

If the motor is regulated by an encoder, then a rotational speed detection and the digital interface for data transfer are already present.

It is known from DE 10 2006 041 056 A1 that the encoder interface can be used to transfer further sensor data. However, the fundamental problem is that the sensor data must be associated with the rotational speed with a very high level of accuracy that cannot be achieved without a synchronization in the case of a parallel digitization of the measured values relating to the encoder position.

One possibility would be to use a sensor that supplies data at the same rate at which the encoder is operated. However, conventional sensors are operated with an internal, relatively inaccurate clock. For this reason, it is not possible to select a sensor with the same data rate as the encoder clock. Furthermore, even if the internal clock of the sensor were to be much more accurate, existing smaller discrepancies between encoder clock and sensor clock would naturally result in great inaccuracies in condition monitoring.

A sensor typically shows that a new signal has been obtained because an interrupt signal is set. Here, the data rate of the sensor may be measured very easily by measuring the periods between two or more interrupts (for example, via a capture input of a uControllers). The encoder clock could be adapted to this data rate to achieve synchronous data acquisition of the encoder and sensor. However, the encoder signals are used for regulating the rotating machine. A continuous adjustment of the encoder clock to the data rate of the sensor would significantly impede this regulating and would therefore not constitute a practicable solution.

### SUMMARY OF THE INVENTION

In view of the foregoing, it is an object of the invention to provide a low-cost and reliable method for monitoring the rotational speed of a rotatable element.

This and other objects and advantages are achieved in accordance with the invention by a rotational speed acquisition unit, in particular a rotary encoder, by a technical unit, by a system and by a method for monitoring a condition of a rotating element.

An inventive rotational speed acquisition unit comprises a first sensor for acquiring a first measured variable dependent on the rotational position of a rotatable element and a second sensor for acquiring a second measured variable different from the first measured variable, where the rotational speed acquisition unit has a first signal output for outputting a rotation signal corresponding with the first measured variable, and where the rotational speed acquisition unit has a second signal output for outputting a measuring signal corresponding with the second measured variable. The first and the second signal outputs can be physically separate signal output components. The same signal output components can also be used for the first and second measured variables. However, it is possible for the signals to be distinguished from each other, for example, via a corresponding modulation. The digital DRIVE-CliQ interface belonging to SIEMENS, for example, can be used as the shared signal output components.

The rotational speed acquisition unit is characterized in that the second sensor has a clock input via which a clock rate of the acquisition of the second measured variable can be adjusted. In addition, it is characterized in that it has a processing unit that is configured to ascertain a clock rate of the acquisition of the first measured variable and to adjust the clock rate of the acquisition of the second measured variable by taking into account the ascertained clock rate of the acquisition of the first measured variable. The processing unit is in this case part of the rotational speed acquisition unit. It is also possible to perform the acquisition of the clock rate of the acquisition of the first measured variable and the adjustment of the second clock rate via a separate processing unit, in the manner described below.

Apart from the actual rotational speed sensor (the first sensor), the rotational speed acquisition unit has at least one further sensor via which an additional measured variable can be acquired. The first and the second measured variables differ from one another. The second measured variable is accordingly not a rotational speed of the rotatable element, but a further measured variable which is connected to the rotatable element or is to be associated with it. The second sensor can be, for example, a temperature sensor, a vibration sensor, an acceleration sensor, a microphone, a pressure sensor, a force sensor, a torque sensor, a displacement sensor, a magnetic field sensor, a voltage sensor or a current sensor. Acquiring the temperature, vibrations, accelerations or further variables means conclusions may be drawn about a condition of the rotatable element, which can be advantageously used for condition monitoring.

The rotational speed acquisition unit particularly advantageously has a second sensor that has a clock input. A processing unit can adjust the clock rate of the acquisition of the second (additional) measured variable to the clock rate of the acquisition of the first measured variable by the first sensor via this clock input. Such (second) sensors with a clock rate that can be adjusted by external specifications have not been known for long and are used particularly advantageously in the context of the present invention to configure the clock rate of the second sensor so it can be adjusted. This involves the great advantage that the second sensor can be synchronized to the first sensor (and not vice versa).

Providing such a clockable second sensor on the rotational speed acquisition unit allows the acquisition of additional data, such as acceleration data, absolutely synchronously with the rotational speed of the rotatable element. This enables a direct order analysis evaluation for condition monitoring. Until now a cost-intensive additional system was necessary for this, with limitations also being associated herewith since a direct coupling of the additional sensor data to the rotational speed of the rotatable element was missing.

The first sensor and/or the second sensor can be connected to the processing unit via a bus interface. The particular advantage of this embodiment is that sensors with a standardized plug can be easily plugged into a corresponding bus connection socket of the rotational speed acquisition unit. The assembly effort is reduced thereby. A further advantage is that the measured variable acquired by a sensor is usually in the form of a digitized measured value that is transferred to the bus interface of the rotational speed acquisition unit. The bus interface can be, for example, a standardized USB interface. A USB plug and a corresponding socket have advantageously compact dimensions. Alternatively, what is known as a Firewire interface based on the Institute of Electrical and Electronics Engineers (IEEE) 1394 standard, a CAN bus or an I²C-bus interface can be used.

The connection can also occur via a terminal strip or socket connector, however, which is arranged in the or on the rotational speed acquisition unit. The respective cable ends of the sensors can be pushed-in or plugged-in and then fixed in the terminal strip or socket connector.

Preferably, the processing unit is a microcontroller, an field programmable gate array (FPGA), an application-specific integrated circuit (ASIC), a discretely constructed circuit or a microprocessor. These components can be flexibly adapted to the requirements of the rotational speed acquisition unit.

Particularly preferably, the rotational speed acquisition unit has a housing, inside of which both the first sensor and the second sensor are arranged. The housing can be manufactured, for example, from aluminum or plastics material. The second sensor can also be arranged outside of the housing, however.

Within the context of a preferred embodiment of the invention, the processing unit is configured to performed the ascertainment of the clock rate of the acquisition of the first measured variable at the beginning of the condition monitoring and to repeat it at particular instants during the course of the condition monitoring. The processing unit can consequently determine potential changes in the clock rate of the first sensor during its operation and update the clock rate of the second sensor accordingly. The reliability of the condition monitoring is increased further hereby.

The objects and advantages are also achieved in accordance with the invention by a technical unit, preferably an electric machine, in particular electric motor, or a transmission, which have a rotating element and a rotational speed acquisition unit for acquiring the first measured variable and the second measured variable.

In addition, the objects and advantages are achieved in accordance with the invention by a system comprising a rotational speed acquisition unit, in particular rotary encoder, with a first sensor for acquiring a first measured variable dependent on the rotational position of a rotatable element and a second sensor for acquiring a second measured variable different from the first measured variable, where the rotational speed acquisition unit has a first signal output for outputting a rotation signal corresponding with the first measured variable, where the rotational speed acquisition unit has a second signal output for outputting a measuring signal corresponding with the second measured variable, and where the second sensor has a clock input via which a clock rate of the acquisition of the second measured variable can be adjusted, or alternatively a technical unit as described above.

The system additionally includes a separate evaluation unit that is connected to the rotational speed acquisition unit and that is configured to ascertain a clock rate of the acquisition of the first measured variable and to adjust the clock rate of the acquisition of the second measured variable by taking into account the ascertained clock rate of the acquisition of the first measured variable.

The inventive system accordingly comprises a rotational speed acquisition unit and a separate (i.e. external) evaluation unit—or a technical unit and the separate evaluation unit.

The separate evaluation unit is established to be separate from the rotational speed acquisition unit. It can be implemented, for example, in a cloud-based environment (with evaluation and control functionalities). However, it can also be implemented in a unit that is configured for a specification of the clock rate of the acquisition of the first measured variable. This simplifies the acquisition of the clock rate of the acquisition of the first measured variable since the unit specifies this clock rate itself.

The objects and advantages are achieved, moreover, in accordance with the invention by a method for monitoring a condition of a rotating element, in particular an electric machine, where the method comprises a) acquiring, via a first sensor of a rotational speed acquisition unit, a first measured variable dependent on the rotational position of the rotatable element and outputting a rotation signal corresponding with the first measured variable, b) ascertaining a clock rate of the acquisition of the first measured variable via a processing unit of the rotational speed acquisition unit or by way of a separate evaluation unit, c) acquiring, via a second sensor of the rotational speed acquisition unit, a second measured variable different from the first measured variable and outputting a measuring signal corresponding with the second measured variable, where the second sensor has a clock input via which a clock rate of the acquisition of the second measured variable can be adjusted, d) adjusting the clock rate of the acquisition of the second measured variable by taking into account the ascertained clock rate of the acquisition of the first measured variable via the processing unit or the separate evaluation unit, and e) using the rotation signal and the measuring signal adjusted to the rotation signal to monitoring the condition of the rotating element.

The clock rate of the acquisition of the first measured variable can be ascertained by the processing unit or the separate evaluation unit at the beginning of the condition monitoring and can be repeated at particular instants during the course of the condition monitoring. The clock rate of the acquisition of the first measured variable can be specified, for example, by a control unit of a converter for an electric machine as the technical unit.

For the case where the second sensor supports the clock rate of the acquisition of the first measured variable as its own clock rate, during the acquisition of the second measured variable, the clock rate of the acquisition of the first measured variable can be used as the clock rate for acquiring the second measured variable during the course of adjusting the clock rate of the acquisition of the second measured variable. As a rule, the second sensor supports a particular bandwidth in the clock rate of its acquisition of the second measured variable. If the clock rate of the acquisition of the first measured variable lies in this band, then the clock rate of the acquisition of the first measured variable can thus be easily used as the clock rate for acquiring the second measured variable. The measuring signals of the first and second sensors can thus be synchronized particularly easily and the data of the second measured variable can be directly associated with the data of the first measured variable for the condition monitoring.

For the case where the second sensor supports a multiple of the clock rate of the acquisition of the first measured variable as its own clock rate during the acquisition of the second measured variable, the multiple of the clock rate of the acquisition of the first measured variable can be used as the clock rate for the acquisition of the second measured variable during the course of adjusting the clock rate of the acquisition of the second measured variable. If the first clock rate is, for example, 100 Hz, but the bandwidth of the second sensor ranges from 150 Hz to 250 Hz, then 200 Hz can be used as the clock rate of the second sensor, and this corresponds to twice the clock rate of the first sensor.

Only a particular part of the rotation signal and/or the measuring signal can be considered for condition monitoring. In the previously described example with a first clock rate of 100 Hz and a second clock rate of 200 Hz, the data of the measuring signal can be decimated to the data of the rotation signal. Specifically, this means that only every second item of sensor data of the second sensor is evaluated.

Advantageously, the rotation signal and/or the measuring signal can be subjected to frequency-dependent filtering to prevent aliasing. In the previous example, this would be the case with the measuring signal because it is decimated while the rotation signal is used in its original state.

However, an interpolation of data of the rotation signal and/or the measuring signal can also be performed for the condition monitoring. In the previously described example with a first clock rate of 100 Hz and a second clock rate of 200 Hz, the data of the rotation signal can be interpolated so that data of the rotation signal also exists for the condition monitoring at the instants of the data of the measuring signal. All data of the measuring signal and all data of the rotation signal as well as additional, interpolated data of the rotation signal would be evaluated thereby.

The multiple does not have to be an integer. It is also possible, for example, to select a ratio between the two clock rates of 4/3 or 7/5. Data of both the rotation signal and the measuring signal can be interpolated for condition monitoring such that the two signals have a clock rate of the lowest common multiple of the clock rate of the acquisition of the first measured variable or of the clock rate of the acquisition of the second measured variable. With a ratio of 4/3 between rotation signal clock rate and measuring signal clock rate, three items of data, for example, would have to be interpolated between the acquired data of the measuring signal and two items of data between the acquired data of the rotation signal. For a better understanding, reference should be made here to the description of the exemplary embodiments and the figures.

For the case where the second sensor supports a fraction of the clock rate of the acquisition of the first measured variable as its own clock rate during the acquisition of the second measured variable, the fraction of the clock rate of the acquisition of the first measured variable can be used as the clock rate for the acquisition of the second measured variable during the course of adjusting the clock rate of the acquisition of the second measured variable. If the first clock rate is, for example, 100 Hz, but the bandwidth of the second sensor ranges from 25 Hz to 75 Hz, 50 Hz can be used as the clock rate of the second sensor, and this corresponds to half the clock rate of the first sensor. Analogously to the previous statements, either data of the measuring signal can be interpolated or data of the rotation signal can be decimated for the condition monitoring.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described properties, features and advantages of this invention as well as the manner in which they are achieved will become clearer and more comprehensible in connection with the following description of exemplary embodiments which will be explained in more detail in connection with the drawings, in which:

FIG. 1 shows a schematic representation of a rotary signal acquisition unit in accordance with the invention;

FIG. 2 shows a temporal comparison of rotation signal and measuring signal in accordance with a first embodiment of the invention;

FIG. 3 shows a temporal comparison of rotation signal and measuring signal in accordance with a second embodiment of the invention;

FIG. 4 shows a temporal comparison of rotation signal and measuring signal in accordance with a third embodiment of the invention;

FIG. 5 shows a temporal comparison of rotation signal and measuring signal in accordance with a fourth embodiment of the invention;

FIG. 6 shows a temporal comparison of rotation signal and measuring signal in accordance with a fifth embodiment of the invention;

FIG. 7 shows a temporal comparison of rotation signal and measuring signal in accordance with a sixth embodiment of the invention;

FIG. 8 is a flowchart of the method in accordance with the invention.

### DETAILED DESCRIPTION OF THE EXEMPLARY EMBODIMENTS

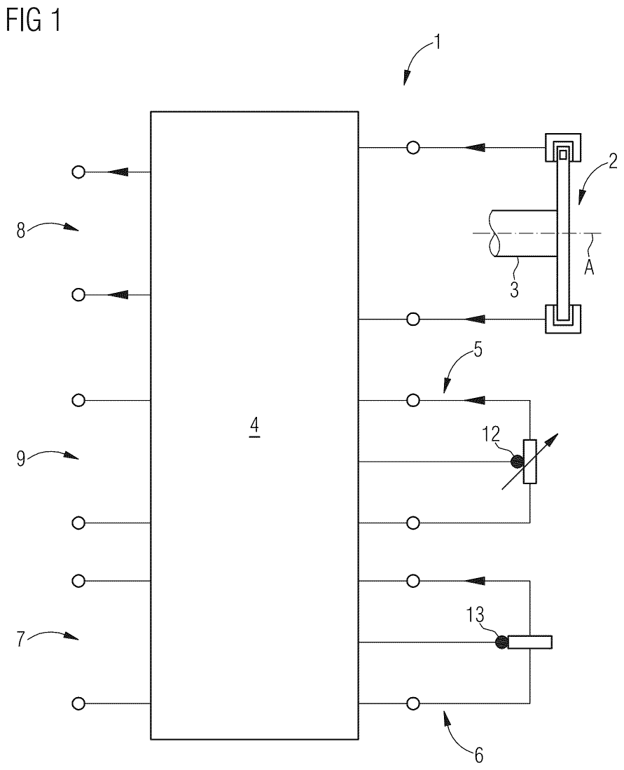

FIG. 1 schematically shows the construction of an inventive rotational speed acquisition unit which is configured as a rotary encoder 1. The rotary encoder 1 has a rotary sensor as a first sensor 2 for acquiring a measured variable dependent on the rotational position of a rotatable element 3. The measured variable can be, for example, an angle in degree units. Reference character A designates the axis of rotation of the rotary encoder 1 or the rotatable element 3. The rotatable element 3 is not represented for reasons of clarity. This object can be, for example, a motor shaft, a rotary plate or the like.

The rotary encoder 1 also has a processing unit 4, a first connection 5 for a first further sensor and a second connection 6 for a second further sensor. In addition, the rotary encoder 1 has a voltage input 7, a signal output 8 for the first sensor 2 and two signal outputs 9 for the further sensors 5, 6. The processing unit 4 serves to distribute the voltage supply 7, the input-side signals of the first sensor 2 and the further sensors 5, 6 to the output-side signal outputs 8, 9 circuitry-wise. The processing unit 4 has a microcontroller.

A rotary position- and direction-dependent rotation signal can be generated from a modulated signal of one of two phototransistors (not represented) of the first sensor 2, where this signal is provided at the sensor output 8. Measuring signals are accordingly provided at the further signal outputs 9 by the further sensors 5, 6. The first further sensor 5 constitutes a temperature sensor with a temperature as the measured variable, while the second further sensor 6 is an acceleration sensor with an acceleration as the measured variable. The further sensors 5, 6 are preferably attached at sites in an electric machine that require monitoring, such as in the winding head or in the region of the motor bearing. The two sensors 5, 6 have an external clock input 12, 13 via which the processing unit 4 can variably set and change a clock rate of the acquisition of the respective measured variable of the two sensors 5, 6.

It should be understood that even only a single further sensor 5 can be connected to the processing unit 4.

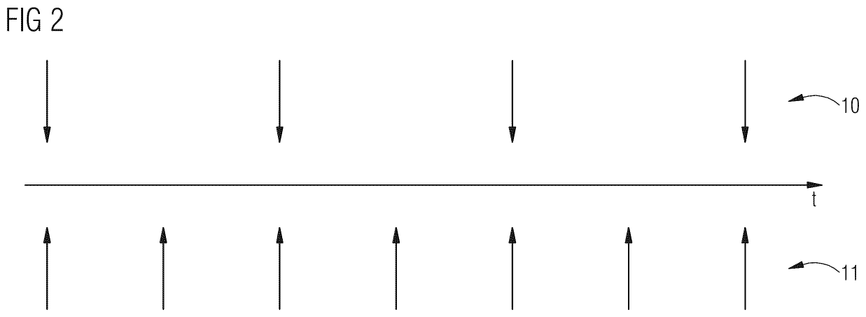

FIG. 2 represents a chronological sequence of the rotation signal 10 (at the top in the figure) tapped at the first signal output 8 and of the measuring signal 11 (acceleration or temperature, at the bottom in the figure) tapped at the second signal output 9. The processing unit 4 has ascertained the clock rate of the acquisition of the first measured variable and adjusted the clock rate of the second sensor 5 (or of the third sensor 6) accordingly. The clock rate of the further sensor 5, 6 could be set to twice the clock rate of the first sensor 2.

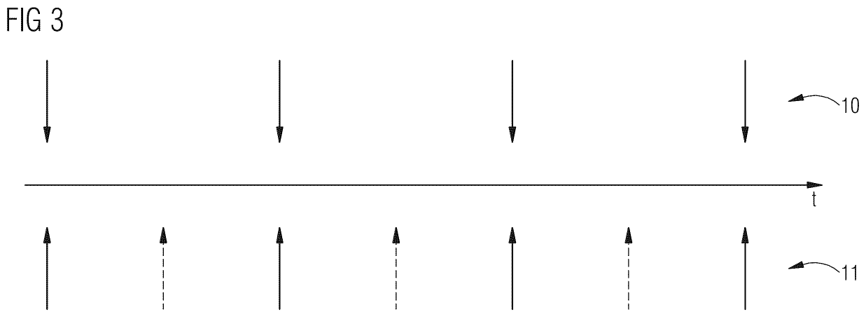

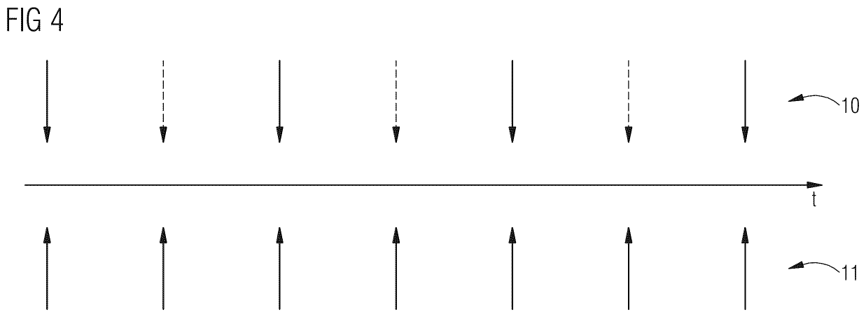

For the condition monitoring, it must be possible to associate each item of data of the measuring signal 11 with exactly one item of data of the rotation signal 10. Therefore, either every second item of data of the measuring signal 11 can be decimated and therewith not be taken into account (represented in FIG. 3 by broken-line arrows), or every second item of data of the rotation signal 10 can be interpolated (represented in FIG. 4 by broken-line arrows).

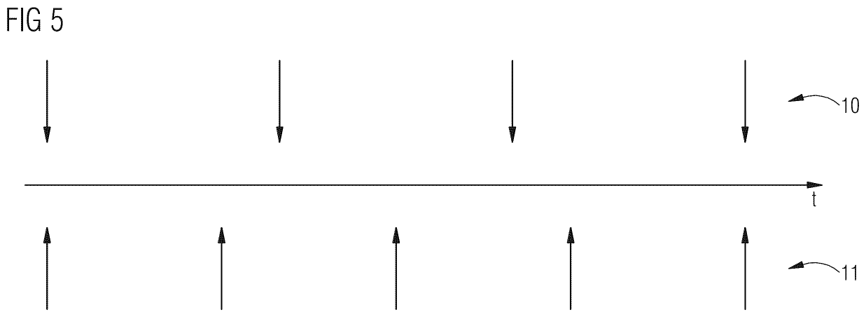

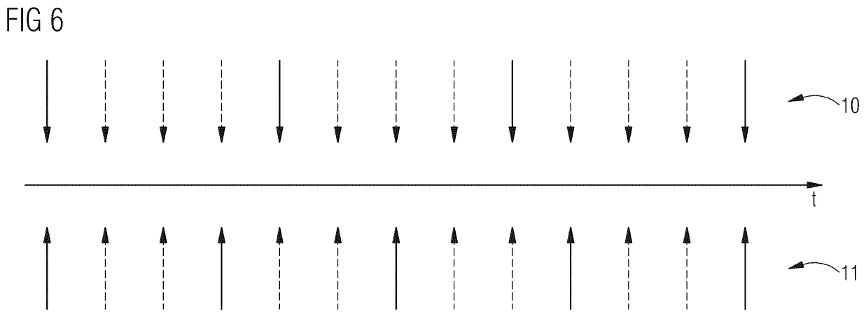

FIG. 5 represents a further chronological sequence of the rotation signal 10 (at the top in the figure) tapped at the first signal output 8 and of the measuring signal 11 (acceleration or temperature, at the bottom in the figure) tapped at the second signal output 9. It can be seen that a ratio of the clock rates of measuring signal 11 and rotation signal 10 is 4:3. The data of measuring signal 11 and rotation signal 10 are interpolated here to a data rate that represents the lowest common multiple of the two data rates. The measuring signal 11 is accordingly interpolated to three times the clock rate, the rotation signal 10 to four times the clock rate, and this can be seen in FIG. 6.

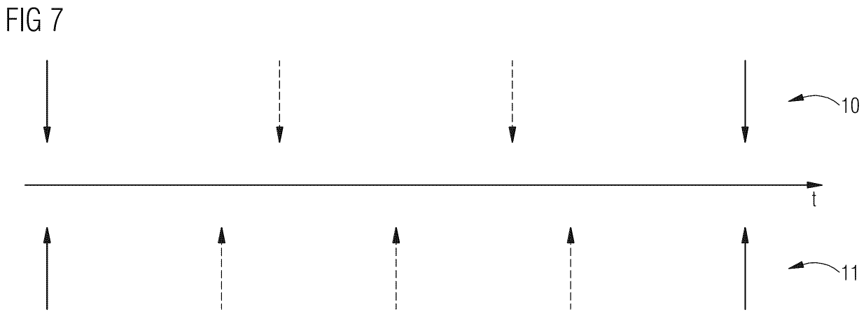

Alternatively, as represented in FIG. 7, part of the data of the rotation signal 10 and of the measuring signal 11 can also be decimated. Mixed forms of decimation and interpolation are also possible.

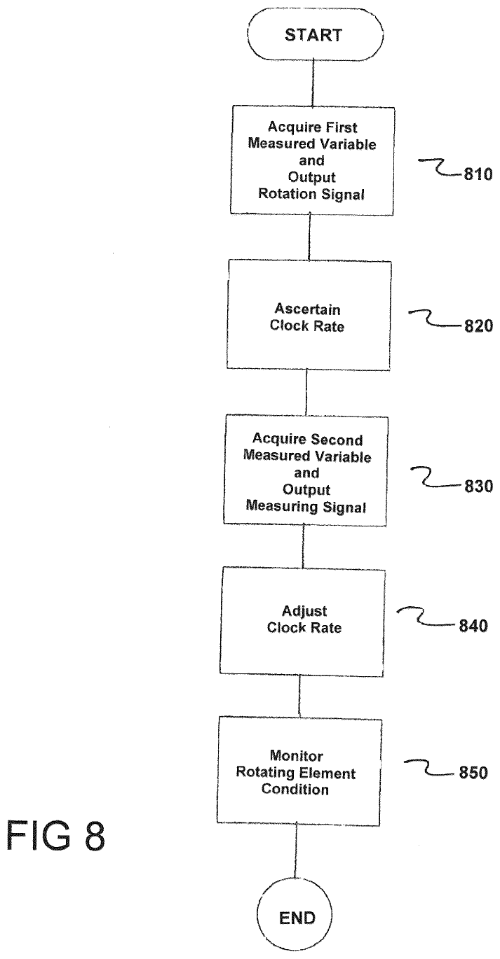

FIG. 8 is a flowchart of the method for monitoring a condition of a rotating element 3. The method comprises a) acquiring, via a first sensor 2 of a rotational speed acquisition unit 1, a first measured variable dependent on the rotational position of the rotatable element 3 and outputting a rotation signal 10 corresponding to the first measured variable, as indicated in step 810.

Next, b) a clock rate of the acquisition of the first measured variable is ascertained via (i) a processing unit of the rotational speed acquisition unit 1 or (ii) a separate evaluation unit, as indicated in step 820.

Next, c) a second measured variable different from the first measured variable is acquired via a second sensor 5, 6 of the rotational speed acquisition unit 1 and a measuring signal 1) corresponding to the second measured variable is output, as indicated in step 830. In accordance with the method of the invention, the second sensor 5, 6 includes a clock input 12, 13 via which a clock rate of the acquisition of the second measured variable is adjustable.

Next, d) the clock rate of the acquisition of the second measured variable is adjusted by taking into account the ascertained clock rate of the acquisition of the first measured variable via (i) the processing unit (4) or (ii) the separate evaluation unit, as indicated in step 840.

Next, e) the condition of the rotating element 3 is monitored via the rotation signal 10 and the measuring signal 11 adjusted to the rotation signal 10, as indicated in step 850.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A rotational speed acquisition unit, comprising:
a first sensor for acquiring a first measured variable dependent on a rotational position of a rotatable element; and
a second sensor for acquiring a second measured variable different from the first measured variable;
wherein the rotational speed acquisition unit includes a first signal output for outputting a rotation signal corresponding to the first measured variable;
wherein the rotational speed acquisition unit includes a second signal output for outputting a measuring signal corresponding to the second measured variable;
wherein the second sensor includes a clock input via which a clock rate of the acquisition of the second measured variable is adjustable; and
wherein the rotational speed acquisition unit includes a processing unit which is configured to ascertain a clock rate of the acquisition of the first measured variable and to adjust the clock rate of the acquisition of the second measured variable by taking into account the ascertained clock rate of the acquisition of the first measured variable.

2. The rotational speed acquisition unit as claimed in claim 1, wherein at least one of the first sensor and the second sensor are connected to the processing unit via a bus interface.

3. The rotational speed acquisition unit as claimed in claim 1, wherein the processing unit comprises one of a microcontroller, a field programmable gate array (FPGA), an application-specific integrated circuit (ASIC), a discretely constructed circuit or a microprocessor.

4. The rotational speed acquisition unit as claimed in claim 1, wherein the second sensor comprises one of a temperature sensor, a vibration sensor, an acceleration sensor, a microphone, a pressure sensor, a force sensor, a torque sensor, a displacement sensor, a magnetic field sensor, a voltage sensor and a current sensor.

5. The rotational speed acquisition unit as claimed in claim 1, further comprising:
a housing within which the first sensor and the second sensor are arranged.

6. The rotational speed acquisition unit as claimed in claim 1, wherein the processing unit is configured to perform ascertainment of the clock rate of the acquisition of the first measured variable at a beginning of condition monitoring and to repeat said ascertainment at particular instants during the condition monitoring.

7. The rotational speed acquisition unit as claimed in claim 1, wherein the rotational speed acquisition unit comprises a rotary encoder,

8. A technical unit including a rotating element and the rotational speed acquisition unit as claimed in claim 1 for acquiring the first measured variable and the second measured variable.

9. The technical unit as claimed in claim 8, wherein the technical unit comprises one of an electric motor and a transmission.

10. A system, comprising:
a rotational speed acquisition unit including a first sensor for acquiring a first measured variable dependent on a rotational position of a rotatable element and a second sensor for acquiring a second measured variable different from the first measured variable;
wherein the rotational speed acquisition unit includes a first signal output for outputting a rotation signal corresponding to the first measured variable;
wherein the rotational speed acquisition unit includes a second signal output for outputting a measuring signal corresponding to the second measured variable; and
wherein the second sensor includes one of (i) a clock input via which a clock rate of the acquisition of the second measured variable is adjustable and (ii) the technical unit as claimed in claim 7, the system further comprising:
a separate evaluation unit which is connected to the rotational speed acquisition unit and which is configured to ascertain a clock rate of the acquisition of the first measured variable and to adjust the clock rate of the acquisition of the second measured variable by taking into account the ascertained clock rate of the acquisition of the first measured variable.

11. The system as claimed in claim 10, wherein the rotational speed acquisition unit comprises a rotary encoder.

12. The system as claimed in claim 10, wherein the evaluation unit is implemented in a cloud-based environment.

13. The system as claimed in claim 10, wherein the evaluation unit is implemented in a unit which is configured for a specification of the clock rate of the acquisition of the first measured variable.

14. A method for monitoring a condition of a rotating element, the method comprising:
a) acquiring, via a first sensor of a rotational speed acquisition unit, a first measured variable dependent on the rotational position of the rotatable element and outputting a rotation signal corresponding to the first measured variable;
b) ascertaining a clock rate of the acquisition of the first measured variable via one of (i) a processing unit of the rotational speed acquisition unit and (ii) a separate evaluation unit;
c) acquiring, via a second sensor of the rotational speed acquisition unit, a second measured variable different from the first measured variable and outputting a measuring signal corresponding to the second measured variable, the second sensor including a clock input via which a clock rate of the acquisition of the second measured variable is adjustable;
d) adjusting the clock rate of the acquisition of the second measured variable by taking into account the ascertained clock rate of the acquisition of the first measured variable via one of (i) the processing unit and (ii) the separate evaluation unit; and
e) monitoring the condition of the rotating element via the rotation signal and the measuring signal adjusted to the rotation signal.

15. The method as claimed in claim 14, wherein the clock rate of the acquisition of the first measured variable is ascertained at a beginning of the condition monitoring and is repeated at particular instants during the condition monitoring.

16. The method as claimed in claim 14, wherein for the cases in which the second sensor supports the clock rate of the acquisition of the first measured variable as its own clock rate during acquisition of the second measured variable, the clock rate of the acquisition of the first measured variable is utilized as the clock rate for the acquisition of the second measured variable when adjusting the clock rate of the acquisition of the second measured variable.

17. The method as claimed in claim 15, wherein for the cases in which the second sensor supports the clock rate of the acquisition of the first measured variable as its own clock rate during acquisition of the second measured variable, the clock rate of the acquisition of the first measured variable is utilized as the clock rate for the acquisition of the second measured variable when adjusting the clock rate of the acquisition of the second measured variable.

18. The method as claimed in claim 14, wherein for cases in which the second sensor supports a multiple of the clock rate of the acquisition of the first measured variable as its own clock rate during acquisition of the second measured variable, the multiple of the clock rate of the acquisition of the first measured variable is utilized as the clock rate for the acquisition of the second measured variable when adjusting the clock rate of the acquisition of the second measured variable.

19. The method as claimed in claim 15, wherein for cases in which the second sensor supports a multiple of the clock rate of the acquisition of the first measured variable as its own clock rate during acquisition of the second measured variable, the multiple of the clock rate of the acquisition of the first measured variable is utilized as the clock rate for the acquisition of the second measured variable when adjusting the clock rate of the acquisition of the second measured variable.

20. The method as claimed in claim 14, wherein for the cases in which the second sensor supports a fraction of the clock rate of the acquisition of the first measured variable as its own clock rate during acquisition of the second measured variable, the fraction of the clock rate of the acquisition of the first measured variable is utilized as the clock rate for the acquisition of the second measured variable when adjusting the clock rate of the acquisition of the second measured variable.

21. The method as claimed in claim 15, wherein for the cases in which the second sensor supports a fraction of the clock rate of the acquisition of the first measured variable as its own clock rate during acquisition of the second measured variable, the fraction of the clock rate of the acquisition of the first measured variable is utilized as the clock rate for the acquisition of the second measured variable when adjusting the clock rate of the acquisition of the second measured variable.

22. The method as claimed in claim 14, wherein at least one of the rotation signal and the measuring signal are subject to frequency-dependent filtering to prevent aliasing.

23. The method as claimed in claim 14, wherein only a particular part of at least one of the rotation signal ( ) and the measuring signal is considered for the condition monitoring.

24. The method as claimed in claim 14, wherein an interpolation of data of at least one of the rotation signal and the measuring signal is performed for the condition monitoring.

25. The method as claimed in claim 14, wherein the rotating element comprises an electric machine.
